(19) United States
(12) Patent Application Publication
(10) Pub. No.: US 2002/0157116 A1
(43) Pub. Date: Oct. 24, 2002

(54) Context and content based information processing for multimedia segmentation and indexing

(75) Inventor: Radu Serban Jasinschi, Ossining, NY (US)

Correspondence Address: Michael E. Marion, U.S. Philips Corporation, 580 White Plains Road, Tarrytown, NY, 10591, US

(73) Assignee: Koninklijke Philips Electronics N.V.

(21) Appl. No.: 09/803,328

(22) Filed: Mar. 9, 2001

Related U.S. Application Data
(60) Provisional application No. 60/221,403, filed on Jul. 28, 2000.

(51) Int. Cl. H04N 7/16; G09G 5/00

(52) U.S. Cl. 725/136; 345/704

(57) ABSTRACT

Method and system are disclosed for information processing, for example, for multimedia segmentation, indexing and retrieval. The method and system includes multimedia, for example audio/visual/text (A/V/T), integration using a probabilistic framework. Both, multimedia content and context information are represented and processed via the probabilistic framework. This framework is represented, for example, by a Bayesian network and hierarchical priors, which is graphically described by stages, each having a set of layers with each layer including a number of nodes representing content or context information. At least the first layer of the first stage is processes multimedia content information such as objects in the A/V/T domains, or combinations of thereof. The other layers of the various stages describe multimedia context information, as further described below. Each layer is a Bayesian network, wherein nodes of each layer explain certain characteristics of the next “lower” layer and/or “lower” stages. Together, the nodes and connections there between form an augmented Bayesian network. Multimedia context is the circumstance, situation, underlying structure of the multimedia information (audio, visual, text) being processed. The multimedia information (both content and context) is combined at different levels of granularity and level of abstraction within the layers and stages.

### BACKGROUND OF THE INVENTION

Multimedia content information, such as from the Internet or commercial TV, is characterized by its sheer volume and complexity. From the data point of view, multimedia is divided into audio, video (visual), and transcript information. This data can be unstructured, that is in its raw format which can be encoded into video streams, or structured. The structured part of it is described by its content information. This can span from clusters of pixels representing objects in the visual domain, to music tunes in the audio domain, and textual summaries of spoken content. Typical processing of content-based multimedia information is a combination of so-called bottom-up with top-down approaches.

In the bottom up approach the processing of multimedia information starts at the signal processing level, also called the low-level, for which different parameters are extracted in the audio, visual, and the transcript domains. These parameters describe typically local information in space and/or time, such as, pixel-based in the visual domain or short-time intervals (10 ms) in the audio domain. Sub-sets of these parameters are combined to generate mid-level parameters that typically describe regional information, such as, spatial areas corresponding to image regions in the visual domain or long time intervals (e.g. 1-5 seconds) in the audio domain. The high-level parameters describe more semantic information; these parameters are given by the combination of parameters from the mid-level; this combination can be either within a single domain or across different domains. This approach requires keeping track of many parameters and it is sensitive to errors in the estimation of these parameters. It is therefore brittle and complex.

The top-down approach is model driven. Given the application domain, specific models are used that structure the output of the bottom-up approach in order help to add robustness to these outputs. In this approach the choice of models is critical, and it cannot be realized in an arbitrary way; domain knowledge is important here, and this requires the constraint in the application domain.

With the increased amounts of multimedia information available to the specialized and general public, users of such information are requiring (i) personalization, (ii) fast and easy access to different portions of multimedia (e.g. video) sequences, and (iii) interactivity. In the last several years progress has been made to satisfy, in a direct or indirect way, some of these user requirements. This includes the development of faster CPUs, storage systems and mediums, and programming interfaces. With respect to the personalization requirement above, products such as TiVo allows the user to record whole or parts of broadcast/cable/satellite TV programs based on his user profile and the electronic program guide. This relatively new application domain, that of personal (digital) video recorders (PVR), requires the incremental addition of new functionalities. These range from user profiles to commercial vs. program separation and content-based video processing. The PVR's integrate PC, storage, and search technologies. The development of query languages for the Internet allows access to multimedia information based mainly on text. In spite of these developments, it is clear that there is a need for improving information segmentation, indexing and representation.

### SUMMARY OF THE INVENTION

Certain problems relating to information processing such as multimedia segmentation, indexing, and representation are reduced or overcome by a method and system in accordance with the principles of the present invention. The method and system includes multimedia, such as audio/visual/text (A/V/T), integration using a probabilistic framework. This framework enlarges the scope of multimedia processing and representation by using, in addition to content-based video, multimedia context information. More particularly, the probabilistic framework includes at least one stage having one or more layers with each layer including a number of nodes representing content or context information, which are represented by Bayesian networks and hierarchical priors. Bayesian networks combine directed acyclic graphs (DAG)—were each node corresponds to a given attribute (paramater) of a given (audio, visual, transcript) multimedia domain and each directed arc describes a causal relationship between two nodes—and conditional probability distributions (cpd)—one per arc. Hierarchical priors augment the scope of Bayesian networks: each cpd can be represented by an enlarged set of internal variables by the recursive use of the Chapman-Kolmogorov equation. In this representation each internal variable is associated to a layer of a particular stage. The cpds without any internal variables describe the structure of a standard Bayesian network, as described above; this defines a base stage. In this case the nodes are associated with content-based video information. Then, cpds with a single internal variable describe either relationships between nodes of a second stage or between nodes of this second stage and that of the base stage. This is repeated for an arbitrary number of stages. In addition to this, nodes in each individual stage are related to each other by forming a Bayesian network. The importance of this augmented set of stages is to include multimedia context information.

Multimedia context information is represented in the hierarchical priors framework as nodes in the different stages, except in the base stage. Multimedia context information is determined by the “signature” or “pattern” underlying the video information. For example, to segment and index a music clip in a TV program, we could distinguish the TV program by genre, such as, a music program (MTV), talk show, or even a commercial; this is contextual information within TV programs. This added context information can contribute to reduce dramatically the processing of video associated with TV programs which is an enormous amount of data and extremely complex to process if semantic information is also determined. What characterizes multimedia context is that it is defined within each domain, audio, visual, and text separately, and it can be defined for the combination of information from these different domains. Context information is distinct from content information; roughly the latter deals with objects and their relationships, while the former deals with the circumstance involving the objects. In TV programs the content “objects” are defined at different levels of abstraction and granularity.

Thus, the invention permits segmentation and indexing of multimedia information according to its semantic characteristics by the combined use of content and context information. This enables (i) robustness, (ii) generality, and (iii) complementarity in the description (via indexing) of the multimedia information.

In one illustrative embodiment of the invention, for example, used for Video Scouting (VS), there are five functionally distinct layers in a first stage. In particular, each layer is defined by nodes and the “lower” nodes are related to the “higher” nodes by directed arcs. Therefore, a directed acyclic graph (DAG) is used, and each node defines a given property described by the Video Scouting system, while arcs between the nodes describe relationships between them; each node and each arc are associated with a cpd. The cpd associated with a node measures the probability that the attribute defining the node is true given the truthfulness of the attributes associated with the parent nodes in the “higher” stage. The layered approach allows differentiation of different types of processes, one for each layer. For example, in the framework of TV program segmentation and indexing, one layer can be used to deal with program segments, while another layer with genre or program style information. This allows a user to select multimedia information at different levels of granularity, e.g., at the program ⇄sub-program ⇄scene⇄shot⇄frame⇄image region⇄image region part⇄part pixel, were a scene is a collection of shots, shots are video units segmented based on changes in color and/or luminance degrees, and objects are audio/visual textual units of information.

The first layer of the Video Scouting, the Filtering layer, comprises the electronic programming guide (EPG) and profiles, one for program personal preferences (P_PP) and the other one for content personal preferences C_PP). The EPG and PP's are in ASCII text format and they serve as initial filters of TV programs or segments/events within programs that the user selects or interacts with. The second layer, the Feature Extraction layer, is divided into three domains, the visual, audio, and textual domains. In each domain a set of “filter banks” that processes information independently of each other selects particular attributes' information. This includes the integration of information within each attribute. Also, using information from this layer, video/audio shots are segmented. The third layer, the Tools layer, integrates information from within each domain from the Feature Extraction layer; the output of it are objects which aid the indexing of video/audio shots. The fourth layer, the Semantic Processes layer, combines elements from the Tools layer. In this case, integration across domains can also occur. Finally, the fifth layer, the User Applications layer, segments and indexes programs or segments of it by combining elements from the Semantic Processes layer. This last layer reflects user inputs via the PP and the C_PP.

### BRIEF DESCRIPTION OF THE DRAWING

The invention will be more readily understood after reading the following detailed description taken in conjunction with the accompanying drawing, in which:

FIG. 1 is an operational flow diagram for a content-based approach;

FIG. 2 illustrates context taxonomy;

FIG. 3 illustrates visual context;

FIG. 4 illustrates audio context;

FIG. 5 illustrates one embodiment of the invention;

FIG. 6 illustrates the stages and layers used in the embodiment of FIG. 5;

FIG. 7 illustrates the context generation used in the embodiment of FIG. 5;

FIG. 8 illustrates a clustering operation used in the embodiment of FIG. 5;

FIG. 9 illustrates another embodiment of the invention having a plurality of stages; and

FIG. 10 illustrates a further embodiment of the invention having two stages showing connections between the stages and the layers of each stage.

### DETAILED DESCRIPTION

The invention is particularly important in the technology relating to hard disc recorders embedded in TV devices, personal video recorders (PVRs), a Video Scouting system of this sort is disclosed in U.S. pat. application Ser. No. 09/442,960, entitled Method and Apparatus for Audio/Data/Visual Information Selection, Storage and Delivery, filled on Nov. 18, 1999, to N. Dimitrova et al., incorporated by reference herein, as well as smart segmentation, indexing, and retrieval of multimedia information for video databases and the Internet. Although the invention is described in relation to a PVR or Video Scouting system, this arrangement is merely for convenience and it is to be understood that the invention is not limited to a PVR system, per se.

One application for which the invention is important is the selection of TV programs or sub-programs based on content and/or context information. Current technology for hard disc recorders for TV devices, for example, use EPG and personal profile (PP) information. This invention can also use EPG and PP, but in addition to these it contains an additional set of processing layers which perform video information analysis and abstraction. Central to this is to generate content, context, and semantic information. These elements allow for the fast access/retrieval of video information and interactivity at various levels of information granularity, specially the interaction through semantic commands.

For example, a user may want to record certain parts of a movie, e.g., James Cameron's Titanic, while he watches other TV programs. These parts should correspond to specific scenes in the movie, e.g., the Titanic going undersea as seen from a distance, a love scene between Jake and Rose, a fight between members of different social casts, etc. Clearly these requests involve high-level information, which combine different levels of semantic information. Currently only an entire program, according to EPG and PP information, can be recorded. In this invention, audio/visual/textual content information is used to select the appropriate scenes. Frames, shots, or scenes can be segmented. Also audio/visual objects, e.g., persons, can be segmented. The target movie parts are then indexed according to this content information. A complementary element to video content is context information. For example, visual context can determine if a scene is outdoors/indoors, if it is day/night, a cloudy/shinny day, etc.; audio context determines from the sound, voice, etc. program categories, and type of voices, sound, or music. Textual context relates more to the semantic information of a program, and this can be extracted from close captioning (CC) or speech-to-text information. Returning to the example, the invention allows context information to be extracted, e.g., night scenes, without performing detailed content extraction/combination, and thus allows indexing of large portions of the movie in a rapid fashion; and a higher level selection of movie parts.

Multimedia Content.

Multimedia content is the combination of Audio/Video/Text (A/V/T) objects. These objects can be defined at different granularity levels, as noted above: program⇄sub-program ⇄scene⇄shot⇄frame⇄object⇄object parts⇄pixels. The multimedia content information has to be extracted from the video sequence via segmentation operations.

Multimedia Context

Context denotes the circumstance, situation, underlying structure of the information being processed. To talk about context is not the same as an interpretation of a scene, sound, or text, although context is intrinsically used in an interpretation.

A closed definition of “context” does not exist. Instead, many operational definitions are given depending on the domain (visual, audio, text) of application. A partial definition of context is provided in the following example. A collection of objects, e.g., trees, houses, people in an outdoor scene during a shinny day. From the simple relationship of these objects, which are 3-D visual objects, we cannot determine the truth of the statement, “An outdoor scene during a shiny day.”

Typically, an object is in front/back of another object(s), or moves with a relative speed, or looks brighter than other object(s), etc. We need context information (outdoors, shiny day, etc.) to disambiguate the above statement. Context underlies the relationship between these objects. A multimedia context is defined as an abstract object, which combines context information from the audio, visual, and text domain. In the text domain there exists a formalization of context in terms of first order logic language, see R. V. Guha, Contexts: A Formalization and some Applications, Stanford University technical report, STAN-CS-91-1399-Thesis, 1991. In this domain context is used as a complementary information to phrases or sentences in order to disambiguate the meaning of the predicates. In fact, contextual information is seen as fundamental to determine the meaning of the phrases or sentences in linguistics and philosophy of language.

The novelty of the concept of “multimedia context” in this invention is that it combines context information across the audio, visual, and textual domains. This is important because, when dealing with vast amount of information from a video sequence, e.g., ⅔ hours of recorded A/V/T data, it is essential to be able to extract a portions of this information that is relevant for a given user request.

Content-Based Approach

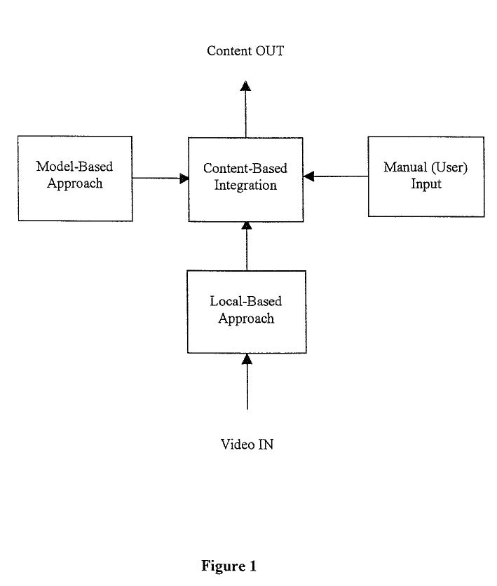

The overall operational flow diagram for the content-based approach is shown in FIG. 1. Being able to track an object/person in a video sequence, to view a particular face shown in a TV news program, or to select a given sound/music in an audio track is an important new element in multimedia processing. The basic characterization of “content” is in terms of “object”: it is a portion or chunk of A/V/T information that has a given relevance, e.g., semantic, to the user. A content can be a video shot, a particular frame in a shot, an object moving with a given velocity, the face of a person, etc. The fundamental problem is how to extract content from the video. This can be done automatically or manually, or a combination of both. In VS the content is automatically extracted. As a general rule, the automatic content extraction can be described as a mixture of local 12 and model 12 based approaches. In the visual domain, the local-based approach starts with operations at the pixel level on a given visual attribute, followed by the clustering of this information to generate region-based visual content. In the audio domain a similar process occurs; for example, in speech recognition, the sound wave form is analyzed in terms of equally spaced 10 ms contiguous/overlapping windows that are then processed in order to produce phoneme information by clustering their information over time. The model-based approaches are important to short cut the “bottom-up” processing done through the local-based approach. For example, in the visual domain, geometric shape models are used to fit to the pixel (data) information; this helps the integration of pixel information for a given set of attributes. One open problem is how to combine the local- and model-based approaches.

The content-based approach has its limitations. Local information processing in the visual, audio, and text domains can be implemented through simple (primitive) operations, and this can be paralleled thus improving speed performance, but its integration 16 is a complex process and the results are, in general, not good. It is therefore that we add context information to this task.

Context-Based Approach

Contextual information circumscribes the application domain and therefore reduces the number of possible interpretations of the data information. The goal of context extraction, and/or detection is to determine the “signature”, “pattern”, or underlying information of the video. With this information we can: index video sequences according to context information and use context information to “help” the content extraction effort.

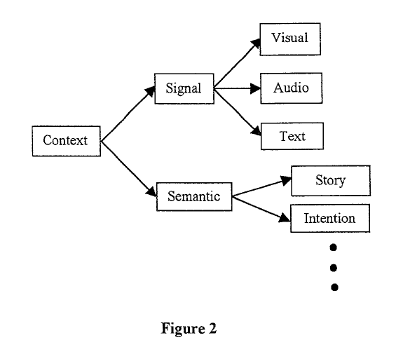

Broadly speaking there are two types of context: signal and semantic context. The signal context is divided into visual, audio, and text context information. The semantic context includes story, intention, thought, etc. The semantic type has a lot of granularity, in some ways, unlimited in possibilities. The signal type has a fixed set of the above mentioned components. FIG. 2 is a flow diagram that shows this so-called context taxonomy.

Next, we describe certain elements of the context taxonomy, i.e., the visual, auditory, and text signal context elements, and the story and intention semantic context elements.

Visual Context

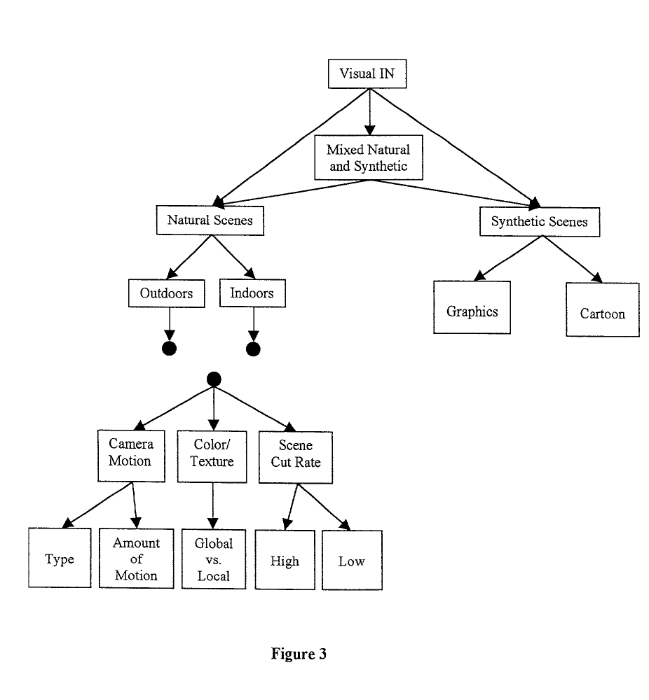

As shown in FIG. 3, context in the visual domain has the following structure. First, a differentiation is made between the natural, synthetic (graphics, design), or the combination of both. Next, for natural visual information, we determine if the video is about an outdoor or indoor scene. If outdoors, then information about how the camera moves, scene shot rate of change, and scene (background) color/texture can further determine context specifics. For example, shots containing slow outdoor scene pans/zooms may be part of sports or documentary programs. On the other hand, fast pans/zooms for indoor/outdoor scenes may correspond to sports (basketball, golf) or commercials. For synthetic scenes, we have to determine if it corresponds to pure graphics and/or traditional cartoon-like imagery. After all these distinctions, we still can determine higher-level context information, e.g., outdoor/indoor scene recognition, but this does involve more elaborate schemes to relate context with content information. Examples of visual context are: indoors vs. outdoors, dominant color information, dominant texture information, global (camera) motion.

Audio Context

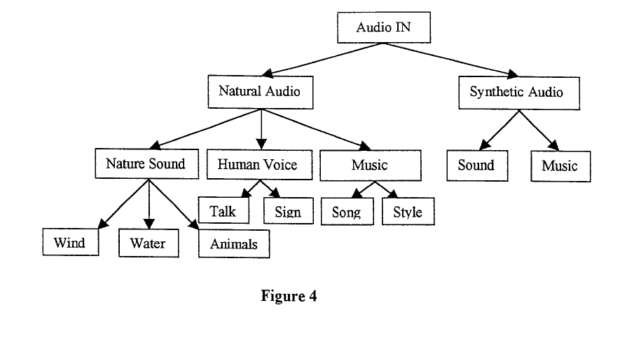

As shown in FIG. 4, in the audio domain, we distinguish, first, between natural and synthetic sound. At the next level, we distinguish between the human voice, nature sounds, and music. For the nature sound we can make a distinction between the sound from animated and unanimated objects, and for the human voice we can differentiate between gender, talk, singing; talking can be differentiated between loud, normal, and low intensity talking. Examples of audio context are nature sounds: wind, animals, trees; human voice: signature (for speaker recognition), singing, talking; music: popular, classical, jazz.

Textual Context

In the text domain, the context information can come from the close captioning (CC), manual transcription, or visual text. For example, from the CC we can use natural language tools to determine if the video is about news, interview program, etc. In addition to this, the VS can have electronic programming guide (EPG) information, plus user choices in terms of (program, content) personal preferences (PP). For example, from the EPG we can use the program, schedule, station, and movie tables, to specify the program category, a short summary of the program content (story, events, etc.), and personnel (actors, announcers, etc.) information. This already helps to reduce the description of context information to a class of treatable elements. Without this initial filtering, context specification becomes an extremely broad problem that can reduce the real use of context information. Thus, textual context information is important for the actual use of context information. Taken together with EPG and PP, the processing of CC information to generate information about discourse analysis and categorization should bootstrap the context extraction process. It is in this sense that the flow of information in VS is “closed loop”.

Combination of Context Information

The combination of context information is a powerful tool in context processing. In particular, the use of textual context information, generated by natural language processing, e.g., key words, can be an important element to bootstrap the processing of visual/audio context.

Context Patterns

One central element in context extraction is “global pattern matching”. Importantly, context is not extracted by, first, extracting content information, and then clustering this content into “objects” which are later related to each other by some inference rules. Instead, we use as little as possible of the content information, and extract context information independently by using, as much as possible, “global” video information. Thus, capturing the “signature” information in the video. For example, to determine if a voice of a person is that of a female or of a male, if the nature sound is that of the wind or of the water, if a scene is shown during daytime and outdoors (high, diffuse luminosity) or indoors (low luminosity), etc. In order to extract this context information, which exhibits an intrinsic “regularity” to it, we use the so-called concept of context pattern. This pattern captures the “regularity” of the type of context information to be processed. This “regularity” might be processed in the signal domain or in the transform (Fourier) domain; it can have a simple or complex form. The nature of these patterns is diverse. For example, a visual pattern uses some combination of visual attributes, e.g., diffuse lighting of daily outdoor scenes, while a semantic pattern uses symbolic attributes, e.g., the compositional style of J. S. Bach. These patterns are generated in the “learning” phase of VS. Together they form a set. This set can always be updated, changed, or deleted.

One aspect of the context-based approach is to determine the context patterns that are appropriate for a given video sequence. These patterns can be used to index the video sequence or to help the processing of (bottom-up) information via the content-based approach. Examples of context patterns are lightness histogram, global image velocity, human voice signature, and music spectrogram.

Information Integration

In accordance with one aspect of the invention, integration (via a probabilistic framework described in detail below) of the different elements, e.g. content and context information, is organized in layer(s). Advantageously, a probabilistic framework allows for the precise handling of certainty/uncertainty, a general framework for the integration of information across modalities, and has the power to perform recursive updating of information.

The handling of certainty/uncertainty is something that is desired in large systems such as Video Scouting (VS). All module output has intrinsically a certain degree of uncertainty accompanying it. For example, the output of a (visual) scene cut detector is a frame, i.e., the key frame; the decision about what key frame to choose can only be made with some probability based on how sharp color, motion, etc. change at a given instant.

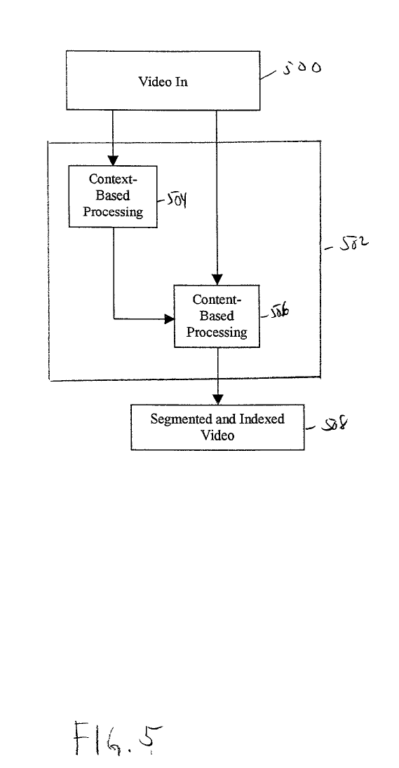

An illustrative embodiment is shown in FIG. 5 that includes a processor 502 to receive an input signal (Video In) 500. The processor performs the context-based processing 504 and content-based processing 56 to produce the segmented and indexed output 508.

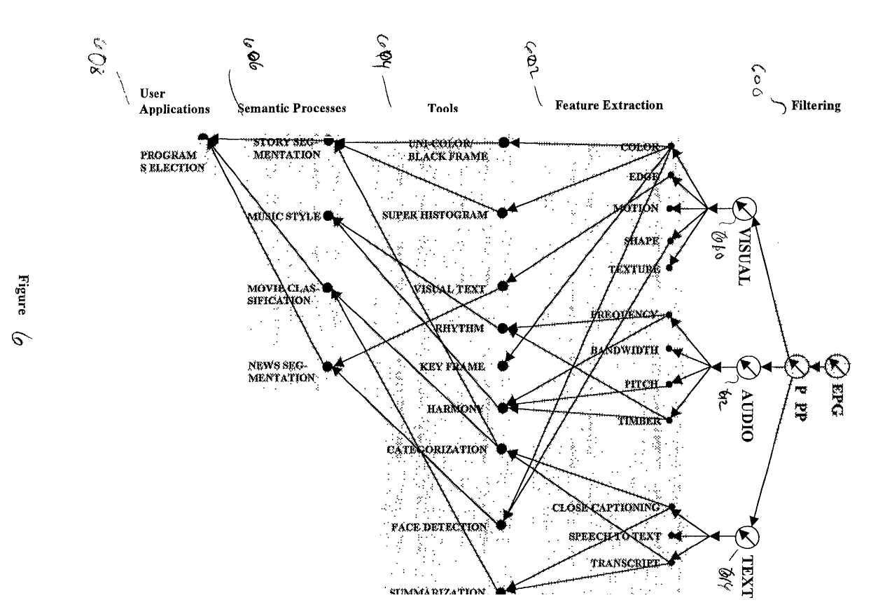

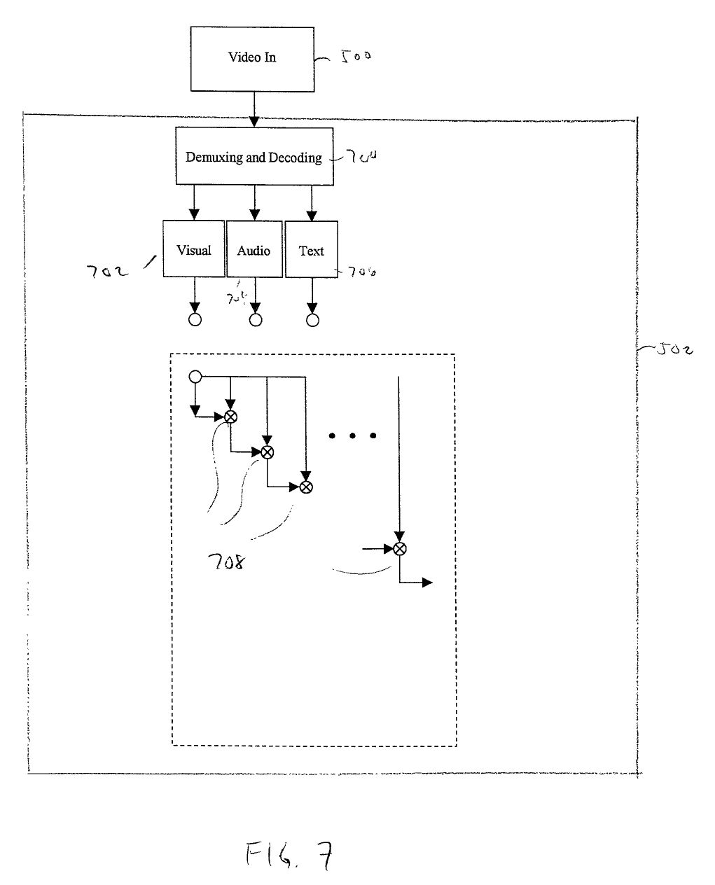

FIGS. 6 and 7 show further details of the context-based processing 504 and content-based processing 506. The embodiment of FIG. 6 includes one stage with five layers in a VS application. Each layer has a different abstraction and granularity level. The integration of elements within a layer or across layers depends intrinsically on the abstraction and granularity level. The VS layers shown in FIG. 6 are the following. Filtering layer 600 via the EPG and (program) personal preference (PP) constitutes the first layer. The second, Feature Extraction layer 602 is made up of the Feature Extraction modules. Following this we have the Tools layer 604 as the third layer. The fourth layer, the Semantic Processes layer 606, comes next. Finally, the fifth layer, the User Applications layer 608. Between the second and third layers we have the visual scene cut detection operation, which generates video shots. If EPG or P_PP is not available, then the first layer is bypassed; this is represented by the arrow-inside-circle symbol. Analogously, if the input information contains some of the features, then the Feature Extraction layer will be bypassed.

The EPG is generated by specialized services, e.g., the Tribune (see the Tribune website at http://www.tribunemedia.com), and it gives, in an ASCII format, a set of character fields which include the program name, time, channel, rating, and a brief summary.

The PP can be a program-level PP (P_PP) or a content-level PP (C_PP). The P_PP is a list of preferred programs that is determined by the user; it can change according to the user's interests. The C_PP relates to content information; the VS system, as well as the user, can update it. C_PP can have different levels of complexity according to what kind of content is being processed.

The Feature Extraction layer is sub-divided into three parts corresponding to the visual 610, audio 612, and text 614 domains. For each domain there exist different representations and granularity levels. The output of the Feature Extraction layer is a set of features, usually separately for each domain, which incorporate relevant local/global information about a video. Integration of information can occur, but usually only for each domain separately.

The Tools layer is the first layer were the integration of information is done extensively. The output of this layer is given by visual/audio/text characteristics that describe stable elements of a video. These stable elements should be robust to changes, and they are used as building blocks for the Semantic Processes layer. One main role of the Tools layer is to process mid-level features from the audio, visual, and transcript domains. This means information about, e.g., image regions, 3-D objects, audio categories such as music or speech, and full transcript sentences.

The Semantic Processes layer incorporates knowledge information about video content by integrating elements from the Tools layer. Finally, the User Applications layer integrates elements of the Semantic Processes layer; the User Applications layer reflects user specifications that are input at the PP level.

In going from the Filtering to the User Applications layer the VS system processes incrementally more symbolic information. Typically, the Filtering layer can be broadly classified as metadata information, the Feature Extraction deals with signal processing information, the Tools layer deals with mid-level signal information, and the Semantic Processes and User Applications layers deal with symbolic information.

Importantly, and in accordance with one aspect of the invention, integration of content information is done across and within the Feature Extraction, Tools, Semantic Processes, and User Applications.

FIG. 7 shows one context generation module. The video-input signal 500 is received by processor 502. Processor 502 demuxes and decodes the signal into component parts Visual 702, Audio 704 and Text 706. Thereafter, the component parts are integrated within various stages and layers as represented by the circled “x”s to generate context information. Finally, the combined context information from these various stages is integrated with content information.

Content Domains and Integration Granularity

The Feature Extraction layer has three domains: visual, audio, and text. The integration of information can be: inter-domain or intra-domain. The intra-domain integration is done separately for each domain, while the inter-domain integration is done across domains. The output of the Feature Extraction layer integration is generates either elements within it (for the intra-domain) or elements in the Tools layer.

The first property is the domain independence property. Given that F_{V}, F_{A}, and F_{T} denote a feature in the visual, audio, and text domains, respectively, the domain independence property is described in terms of probability density distributions by the three equations:

P(F_{V}, F_{A})=P(F_{V})×P(F_{A}), Equation 1

P(F_{V}, F_{T})=P(F_{V})×P(F_{T}), Equation 2

P(F_{A}, F_{T})=P(F_{A})×P(F_{T}). Equation 3

The second property is the attribute independence property. For example, in the visual domain we have color, depth, edge, motion, shading, shape, and texture attributes; in the audio domain we have pitch, timber, frequency, and bandwidth attributes; in the text domain attribute examples are close captioning, speech to text, and transcript attributes. For each domain, the individual attributes are mutually independent.

Now, going into a more detailed description of Feature Extraction integration, we note that, for each attribute in a given domain, there are, generally, three basic operations: (1) filter bank transformation, (2) local integration, and (3) clustering.

The Filter bank transformation operation corresponds to applying a set of filter banks to each local unit. In the visual domain, a local unit is a pixel or a set of them in, e.g., a rectangular block of pixels. In the audio domain each local unit is, e.g., a temporal window of 10 ms as used in speech recognition. In text domain the local unit is the word.

The local integration operation is necessary in cases when local information has to be diss-ambigued. It integrates the local information extracted by the filter banks. This is the case for the computation of 2-D optical flow: the normal velocity has to be combined inside local neighborhoods or for the extraction of texture: the output of spatially oriented filters has to be integrated inside local neighborhoods, e.g., to compute the frequency energy.

The clustering operation clusters the information obtained in the local integration operation inside each frame or sets of them. It describes, basically, the intra-domain integration mode for the same attribute. One type of clustering is to describe regions/objects according to a given attribute; this may be in terms of average values or in terms of higher order statistical moments; in this case, the clustering implicitly uses shape (region) information with that of a target attribute to be clustered. The other type is to do it globally for all image; in this case global qualifications are used, e.g., histograms.

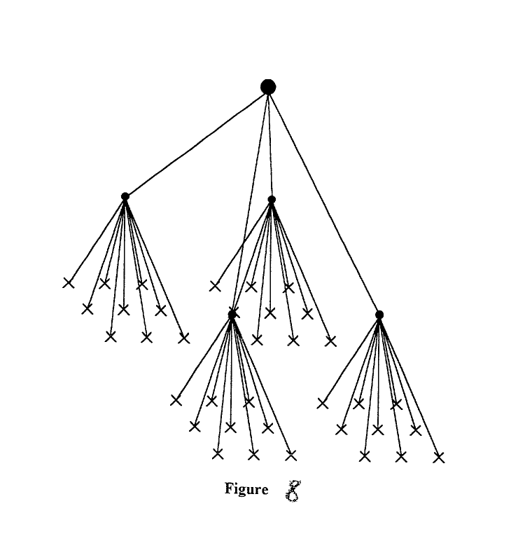

The output of the clustering operation is identified as that of the Feature Extraction. Clearly, inside the Feature Extraction process there is a dependency between each of the three operations. This is shown diagrammatically in FIG. 8 for the visual (image) domain.

The crosses in FIG. 8 denote the image sites at which local filter bank operations are realized. The lines converging onto the small filled circles show the local integration. The lines converging onto the large filled circle display the regional/global integration.

The operations done at each local unit (pixel, block of pixels, time interval, etc.) are independent, e.g., at the location of each cross in FIG. 8. For the integration operation the resulting outputs are dependent, especially inside close neighborhoods. The clustering results are independent for each region.

Finally, integration of feature attributes across domains. For this case the integration is not between local attributes, but between regional attributes. For example, in the so-called lip-speech synchronization problem the visual domain feature(s) given by the mouth opening height, i.e., between points along the line joining the “center” of the lower and upper inner lips, mouth opening width, i.e., between the right and left extreme points of the inner or outer lips, or the mouth opening area, i.e., associated with the inner or outer lips, is (are) integrated with the audio domain feature, i.e., (isolated or correlated) phonemes. Each of these features is in itself the result of some information integration.

The integration of information from the Tools layer to generate elements of the Semantic Processes layer, and from the Semantic Processes layer to generate elements of the User Application layer is more specific. In general, the integration depends on the type of application. The units of video within which the information is integrated in the two last layers (Tools, Semantic Processes) are video segments, e.g., shots or whole TV programs, to perform story selection, story segmentation, news segmentation. These Semantic Processes operate over consecutive sets of frame and they describe a global/high level information about the video, as discussed further below.

Bayesian Networks

As noted above, the framework used for the probabilistic representation of VS is based on Bayesian networks. The importance of using a Bayesian network framework is that it automatically encodes the conditional dependency between the various elements within each layer and/or between each layer of the VS system. As shown in FIG. 6, in each layer of the VS system there exits a different type of abstraction and granularities. Also, each layer can have its own set of granularities.

Detailed descriptions of Bayesian networks are known, see Judea Pearl, Probabilistic Reasoning in Intelligent Systems: Networks of Plausible Inference, Morgan Kaufmann, San Mateo, Calif., 1988 and David Heckerman, “A Tutorial on Learning with Bayesian Networks”, Microsoft Research technical report, MSR-TR-95-06, 1996. In general, Bayesian networks are direct acyclical graphs (DAG) in which: (i) the nodes correspond to (stochastic) variables, (ii) the arcs describe a direct causal relationship between the linked variables, and (iii) the strength of these links is given by cpds.

Let the set Ω≡{x₁, . . . , x_{N}} of N variables define a DAG. For each variable, say there exist a sub-set of variables of Ω, Πₓ_{ᵢ}, the parents set of xᵢ, i.e., the predecessors of xᵢ in the DAG, such that

P(xᵢ|Πₓ_{ᵢ})=P(x₁, . . . , xᵢ₋₁), Equation 4

were P(.|.) is a cpd which is strictly positive. Now, given the joint probability density function (pdf) P(x₁, . . . , x_{N}), using the chain rule we get:

P(x₁, . . . , x_{N})=P(x_{N}|x_{N-1}, . . . x₁). . . P(x₂|x₁)P(x₁). Equation 5

According to Equation 15, the parent set Πₓ_{ᵢ} has the property that xᵢ and {x₁, . . . , x_{N}}\Πₓ_{ᵢ} are conditionally independent given Πᵢ.

The joint pdf associated with the DAG is:

P(x₁, x₂, x₃, x₄, x₅)=P(x₅|x₄)P(x₄|x₃, x₂)P(x₂|x₁)P(x₃|x₁)P(x₁). Equation 6

The dependencies between the variables are represented mathematically by Equation 6. The cpfs in Equations 4, 5, and 6 can be physical or they can be transformed, via the Bayes' theorem, into expressions containing the prior pdfs.

FIG. 6 shows a flow diagram of the VS system that has the structure of a DAG. This DAG is made up of five layers. In each layer, each element corresponds to a node in the DAG. The directed arcs join one node in a given layer with one or more nodes of the proceeding layer. Basically, four sets of arcs join the elements of the five layers. There exists a limitation to this in that from the first layer—the Filtering layer, to the second layer—the Feature Extraction layer, in general, all three arcs are traversed with equal weight i.e., the corresponding pdfs are all equal to 1.0.

For a given layer, and for a given element, we compute the joint pdf as described by Equation 6. More formally, for an element (node) iₗ in layer l the joint pdf is:

P^{(l)}(xᵢ^{(l)}, Π^{(l-1)}, . . . , Π⁽²⁾,)=P(xᵢ^{(l)}|Πᵢ^{(l)}){P(x₁^{(l-1)}|Π₁^{(l-1)}) . . . P(x_{N}_{^{(l-1)}}^{(l-1)}|Π_{N}_{^{(l-1)}}^{(l-1)})}. . . {P(x₁⁽²⁾|Π₁⁽²⁾) . . . P(x_{N}_{⁽²⁾}⁽²⁾|Π_{N}_{⁽⁽²⁾}⁽²⁾)}. Equation 7

It is implicit in Equation 7 that for each element xₗ^{(l)} there exists a parent set Πᵢ^{(l)}; the union of the parent sets for a given level

$${\prod }^{( l )} ≡ {\sum }_{i = 1}^{{N}^{( l )}} {\prod }_{i}^{( l )} .$$

There can exist an overlap between the different parent sets for each level.

As discussed above, the integration of information in VS occurs between four layers: (i) Feature Extraction and Tools, (ii) Tools and segmentation processes, and (iii) Semantic Processes and User Applications. This integration is realized via an incremental process involving the Bayesian network formulation of VS.

The basic unit of VS to be processed is the video shot. The video shot is indexed according to the P_PP and C_PP user specifications according to the schedule shown in FIG. 6. The clustering of video shots can generate larger portions of video segments, e.g., programs.

Let V(id, d, n, ln) denote a video stream, where id, d, n, ln denote the video identification number, data of generation, name, and length, respectively. A video (visual) segment is denoted by VS (t_{f}, tᵢ; vid), where t_{f}, tᵢ, vid, denote the final frame time, initial frame time, and video indexes, respectively. A video segment VS(.) can or not be a video shot. If VS(.) is a video shot, denoted by VSh(.), then the first frame is a keyframe associated with visual information which is denoted by tᵢᵥₖ. The time t_{fvk} denotes the final frame in the shot. Keyframes are obtained via the shot cut detection operator. While a video shot is being processed, the final shot frame time is still unknown. Otherwise we write VSh (t, tᵢᵥₖ; vid), were t<t_{fvk}. An audio segment is denoted by AS (t_{f}, tᵢ; aud), were aud represents an audio index. Similarly with video shots, an audio shot ASh (t_{fak}, tᵢₐₖ; aud) is an audio segment for which t_{fak} and tᵢₐₖ denote the final and initial audio frames, respectively. Audio and video shots do not necessarily overlap; there can be more than one audio shot within the temporal boundaries of a video shot, and vice-versa.

The process of shot generation, indexing, and clustering is realized incrementally in VS. For each frame, the VS processes the associated image, audio, and text. This is realized at the second layer, i.e., at the Feature Extraction layer. The visual, audio, and text (CC) information is first demuxed, and the EPG, P_PP, and C_PP data is assumed to be given. Also, the video and audio shots are updated. After the frame by frame processing is completed, the video and audio shots are clustered into larger units, e.g., scenes, programs.

At the Feature Extraction layer, parallel processing is realized: (i) for each domain (visual, audio, and text), and (ii) within each domain. In the visual domain images—I(.,.) are processed, in the audio domain sound waves—SW are processed, and in the textual domain character strings—CS are processed. A shorthand for the visual (v), audio (a), or text (t) domains is D_{α}; for α=1 we have the visual domain, for 2 we have the audio domain, and for 3 we have the textual domain. The outputs of the Feature Extraction layer are objects in the set {O_{D}_{_{α}}_{,i}^{FE}}ᵢ. The ith object O_{D}_{_{α}}_{,i}^{FE}(t) is associated with the ith attribute A_{D}_{_{α}}_{,i} (t) at time t. At time t the object O_{D}_{_{α}}_{,i}^{FE}(t) satisfies the condition:

P_{D}_{_{α}}(O_{D}_{_{α}}_{,i}^{FE}(t)|A_{D}_{_{α}}_{,i}(t)εR_{D}_{_{α}}). Equation 8

In Equation 8, the symbol A_{D}_{_{α}}_{,i}(t)εR_{D}_{_{α}} means that the attribute A_{D}_{_{α}}_{,i}(t) occurs/is part of (ε) the region (partition) R_{D}_{_{α}}. This region can be a set of pixels in images, or temporal windows (e.g., 10 ms) in sound waves, or a collection of character strings. In fact, Equation 8 is a shorthand representing the three stage processing, i.e., filter bank processing, local integration, and global/regional clustering, as described above. For each object O_{D}_{α}_{^{,i}}^{FE}(t) there exits a parent set Π_{O}_{_{Dα,i}}_{^{FE}}₍ₜ₎;

for this layer the parent set is, in general, large (e.g., pixels in a given image region); therefore it is not described explicitly. The generation of each object is independent of the generation of other object within each domain.

The objects generated at the Feature Extraction layer are used as input to the Tools layer. The Tools layer integrates objects from the Feature Extraction layer. For each frame, objects from the Feature Extraction layer are combined into Tools objects For a time t the Tools object O_{D}_{α}_{^{,i}}^{T}(t) and a parent set Π_{O}_{_{Dα,i}}_{^{T}}₍ₜ₎ of Feature Extraction objects defined in a domain D_{α}, the cpd

P(O_{D}_{_{α}}_{,i(t)}^{T}|Π_{O}_{_{Dα,i}}_{^{T}}₍ₜ₎) Equation 9

means that O_{D}_{α}_{^{,i(t)}}^{T} is conditionally dependent on the objects in Π_{O}_{_{Dα,i}}_{^{T}}₍ₜ₎.

At the next layer, the Semantic Processes layer, the integration of information can be across domains, e.g., visual and audio. The Semantic Processes layer contains objects {Oᵢ^{SP}(t)}₁; each object integrates tools from the Tools layer which is used to segment/index video shots. Similarly to Equation 9, the cpd

P(Oᵢ^{SP}(t)|Π_{O}_{ᵢ}_{^{SP}}₍ₜ₎) Equation 10

describes the Semantic Processes integration process, where Π_{O}ᵢ^{SP}₍ₜ₎ denotes the parent set of Oᵢ^{SP} (t) at time t.

Segmentation, as well as, incremental shot segmentation and indexing is realized using Tools elements, and the indexing is done by using elements from the three layers, Feature Extraction, Tools, and Semantic Processes.

A video shot at time t is indexed as:

VShᵢ(t,tᵢᵥₖ;{χ_{λ}(t)}_{λ}), Equation 11

where i denotes the video shot number, χ_{λ}(t) denotes the λ th indexing parameter of the video shot. χ_{λ}(t) includes all possible parameters that can be used to index the shot, from local, frame-based parameters (low-level, related to Feature Extraction elements) to global, shot-based parameters (mid-level, related to Tools elements and high-level, related to Semantic Processes elements). At each time t (we can represent it as a continuous or discrete variable—in the later case it is written as k), we compute the cpd

P(F(t)⊂VShᵢ(t,tᵢᵥₖ;{χ_{λ}(t)}_{λ})|{A_{D}_{ᵢ}_{,J}(t)}ⱼ), Equation 12

which determines the conditional probability that frame F(t) at time t is contained in the video shot VShᵢ(t, tᵢᵥₖ; {χ_{λ}(t)}_{λ}) given the set of Feature Extraction attributes {A_{D}_{₁}_{,J}(t)}_{J}) in the visual domain D₁ at time t. In order to make the shot segmentation process more robust, we can use Feature Extraction attributes not only obtained at time t but also from previous times, i.e., the set {A_{D}_{₁}_{,J}(t)}_{j,t} replaces {A_{D}_{₁}_{,J}(t)}_{J}. This is realized incrementally via the Bayesian updating rule, that is:

P(F(t)⊂VShᵢ(t,tᵢᵥₖ;{χ_{λ}(t)}_{λ})|{A_{D}_{₁}_{,j}(t)}_{j,t})=

[P({A_{D}_{₁}_{,j}(t)}ⱼ|F(t)⊂VShᵢ(t, tᵢᵥₖ; {χ_{λ}(t)}_{λ}))×

P(F(t)⊂VShᵢ(t, tᵢᵥₖ; {χ_{λ}(t)}_{λ})|{A_{D}_{₁}_{,j}(t−1)}_{j,t-1})]×C, Equation 13

where C is a normalization constant (usually a sum over the states in Equation 13). The next item is the incremental updating of the indexing parameters in Equation 12. First, the process of estimating the indexing parameters based on the (temporarily) expanded set of attributes {A_{D}_{₁}_{,j}(t)}_{j,t}. This is done via the cpd:

P(VShᵢ(t, tᵢᵥₖ; {χ_{λ}(t)=x_{λ}(t)}_{λ})|{A_{D}_{₁}_{,j}(t)}_{j,t}), Equation 14

where x_{λ}(t) is a given measured value of χ_{λ}(t). Based on Equation 14, the incremental updating of the indexing parameters, using the Bayesian rule, is given by:

P(VShᵢ(t, tᵢᵥₖ;{χ_{λ}(t)=x_{λ}(t)}_{λ})|{A_{D}_{₁}_{,J}(t)}_{j,t})=

P({A_{D}_{₁}_{,j}(t)}ⱼ|VShᵢ(t, tᵢᵥₖ{χ_{λ}(t)=x_{λ}(t)}_{λ}))×

P(VShᵢ(t, tᵢᵥₖ;{χ_{λ}(t)=x_{λ}(t)}_{λ})|{A_{D}_{₁}_{,J}(t−1)}_{j,t-1})×C. Equation 15

Tools and/or Semantic Processes elements can also index Video/audio shots. An analogous set of expressions to Equations 12, 13, 14, and 15 apply for the segmentation of audio shots.

Information Representation:

The representation of content/context information, from the Filtering to the VS User Applications layer cannot be unique. This is a very important property. The representation depends on how much level of details of the content/context information the user requires from VS, on the implementation constraints (time, storage space, etc.), and on the specific VS layer.

As an example of this diversity of representations, at the Feature Extraction layer the visual representation can have representations at different granularities. In 2-D space, the representation is made up of images (frames) of the video sequence, each image is made up of pixels or rectangular blocks of pixels; for each pixel/block we assign a velocity (displacement), color, edge, shape, and texture value. In 3-D space, the representation is by voxels, and a similar (as in 2-D) set of assigned visual attributes. This is a representation at the fine level of detail. At a coarser level, the visual representation is in terms of histograms, statistical moments, and Fourier descriptors. These are just an example of possible representations in the visual domain. A similar thing happens for the audio domain. A fine level presentation is in terms of time windows, Fourier energy, frequency, pitch, etc. At the coarser level we have phonemes, tri-phones, etc.

At the Semantic Processes and at the User Applications layers the representation is a consequence of inferences made with the representations of the Feature Extraction layer. The results of the inferences at the Semantic Processes layer reflect multi-modal properties of video shot segments. On the other hand, inferences done at the User Applications layer represent properties of collections of shots or of whole programs that reflect high level requirements of the user.

Hierarchical Prior

According to another aspect of the invention, hierarchical priors in the probabilistic formulation are used, i.e., for the analysis and integration of video information. As noted above, multimedia context is based on hierarchical priors, for additional information on hierarchical priors see J. O. Berger, Statistical Decision Theory and Bayesian Analysis, Springer Verlag, NY, 1985. One way of characterizing hierarchical priors is via the Chapman-Kolmogorov equation, see A. Papoulis, Probability, Random Varibles, and Stochastic Processes, McGraw-Hill, NY, 1984. Let us have a conditional probability density (cpd) p(xₙ, . . . , xₖ₊₁|xₖ, . . , x₁) of n continuous or discrete variables distributed as n−k−1 and k variables. It can be shown that:

p(xₙ,. . . , xₗ, xₗ₊₂, . . . , xₖ₊₁|xₖ, . . . , xₘ, xₘ₊₂, . . . , x₁)=

∫_{-∞}^{∞}d\overline{x}ₗ₊₁{∫_{-∞}^{∞}d\overline{x}ₘ₊₁[p(xₙ, . . . x, ₗ, \overline{x}ₗ₊₁, xₗ₊₂, . . . , xₖ₊₁|xₖ, . . . , xₘ, \overline{x}ₘ₊₁, xₘ₊₂, . . . , x₁)

×p(\overline{x}ₘ₊₁|xₖ, . . . , xₘ, xₘ₊₂, . . . , x₁)]}, Equation 16

were “∫_{-∞}^{∞}” denotes either an integral (continuous variable) or a sum (discrete variable). A special case of Equation 16 with n=1 and k=2 is the Chapman-Kolmogorov equation:

p(x₁|x₂)=∫_{-∞}^{∞}d\overline{x}₃p(x₁|\overline{x}₃, x₂)×p(\overline{x}₃|x₂). Equation 17

Now, let us restrict our discussion to the case with n=k=1. Also, let us assume that x₁is a variable to be estimated and x₂ is the “data”. Then, according to Bayes' theorem:

p(x₁|x₂)=[p(x₂|x₁)×p(x₁)]/p(x₂), Equation 18

were p(x₁|x₂) is called the posterior cpd of estimating x₁ given x₂, p(x₂|x₁) is the likelihood cpd of having the data x₂ given the variable x₁ to be estimated, p(x₂) is the prior probability density (pd), and p(x₁) is a “constant” depending solely on the data.

The prior term p(x₁) does, in general, depend on parameters, specially when the it is a structural prior; in the latter case, this parameters is also called a hyper-parameter. Therefore p(x₁) should be actually written as p(x₁|λ), were λ is the hyper-parameter. Many times we don't want to estimate λ but instead we have a prior on it. In this case, in place of p(x₁|λ) we have p(x₁|λ)×p′(λ), were p′(λ) is the prior on. This process can be expanded for an arbitrary number of nested priors. This scheme is called hierarchical priors. One formulation of the hierarchical priors is described for the posterior, via Equation 17. Take p(\overline{x}₃|x₂), with \overline{x}₃=λ₁, and re-write Equation 17 for it:

p(λ₁|x₂)=∫_{-∞}^{∞}dλ₂p(λ₁|λ₂, x₂)×p(λ₂|x₂). Equation 19

or p(x₁|x₂)=∫_{-∞}²⁸dλ₁∫_{-∞}^{∞}dλ₂p(x₁|λ₁, x₂)×p(λ₁|λ₂, x₂)×p(λ₂|x₂). Equation 20

Expression Equation 20 describes a two-layer prior, that is, a prior for another prior parameter(s). This can be generalized to an arbitrary number of layers. For example in Equation 20 we can use Equation 17 to write p(λ₂|x₂) in terms of another hyper-parameter. There, in general we have as a generalization of Equation 20 for a total of m layered priors:

p(x₁|x₂)=∫_{-∞}^{∞}dλ₁, . . . ∫_{-∞}^{∞}dλₘp(x₁|λ₁, x₂)

×p(λ₁|λ₂, x₂)×. . . ×p(λₘ₋₁|λₘ, x₂)×p(λₘ|x₂). Equation 21

This can also be generalized for an arbitrary number n of conditional variables, that is, from p(x₁|x₂)to p(x₁|x₂, . . . , xₙ).

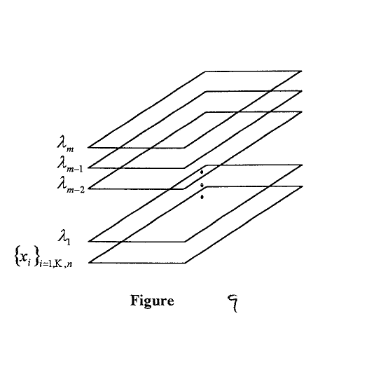

FIG. 9 shows another embodiment of the invention, in which there are a set of m stages to represent the segmentation and indexing of multimedia information. Each stage is associated with a set of priors in the hierarchical prior scheme, and it is described by a Bayesian network. The λ variables are each associated with a given stage, that is, the i th λ variable, λᵢ, is associated with the i th stage. Each layer corresponds to a given type of multimedia context information.

Going back to the case of 2 stages, as in Equation 17 reproduced here in the new notation:

p(x₁|x₂)=∫_{-∞}^{∞}dλ₁p(x₁|λ₁, x₂)×p(λ₁|x₂). Equation 22

Initially, p(x₁|x₂) states a (probabilistic) relationship between x₁ and x₂. Next, by incorporating the variable λ₁ into the problem, we see that: (i) the cpd p(x₁|x₂) depends now on p(x₁|λ₁, x₂), which means that in order to appropriately estimate x₁ it is necessary to know about x₂ and λ₁; (ii) we have to know how to estimate λ₁ from x₂. For example, in the domain of TV programs, if we want to select a given music clip inside a talk show, then x₁=“select a music clip inside a talk show”, x₂=“TV program video-data”, and λ₁=“talk show based on audio, video, and/or text cues”. What the approach based on hierarchical priors gives us as new compared to the standard approach of computing p(x₁|x₂) without Equation 22 is the additional information described by λ₁. This additional information has also to be inferred from the data (x₂) but it is of a different nature than that of x₁; it describes the data from another point of view, say TV program genre than just looking at shots or scenes of the video information. The estimation of λ₁ based on the data x₂ is done at the second stage; the first stage is concerned with estimating x₁ from the data and λ₁. Generally, there exists a sequential order of processing the various parameters. First, the λ parameters, from the second upwards to the m th stage, then the x parameters at the first stage.

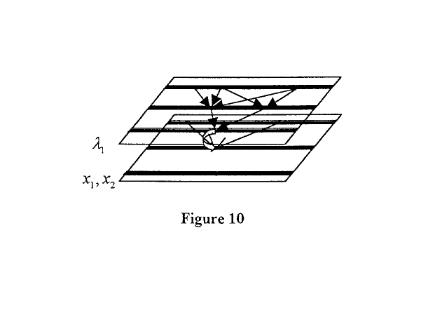

In FIG. 10, the first stage consists of a Bayesian network involving variables x₁, x₂. In the second stage above, the various λ₁ variables (remember that λ₁ does really represent a collection of “prior” variables at the second layer) for another Bayesian network. In both stages the nodes are inter-connected through straight arrows. Now, the curly arrow show a connection between a node in the second stage with a node in the first stage.

In a preferred embodiment, the method and system is implemented by computer readable code executed by a data processing apparatus (e.g. a processor). The code may be stored in a memory within the data processing apparatus or read/downloaded from a memory medium such as a CD-ROM or floppy disk. This arrangement is merely for convenience and it is to be understood that the implementation is not limited to a data processing apparatus, per se. As used herein, the term “data processing apparatus” refers to any type of (1) computer, (2) wireless, cellular or radio data interface appliance, (3) smartcard, (4) internet interface appliance and (5) VCR/DVD player and the like, which facilitates the information processing. In other embodiments, hardware circuitry may be used in place of, or in combination with, software instructions to implement the invention. For example, the invention may implemented on a digital television platform using a Trimedia processor for processing and a television monitor for display.

Moreover, the functions of the various elements shown in the FIGS. 1-10, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included.

The following merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

What is claimed is:

1. A data processing device for processing an information signal comprising:
at least one stage, wherein a first stage includes,
a first layer having first plurality of nodes for extracting content attributes from the information signal; and
a second layer having at least one node for determining context information for the at least one node using the content attributes of selected nodes in an other layer or a next stage, and for integrating certain ones of the content attributes and the context information at the at least one node.

2. The data processing device according to claim 1, further including a second stage, the second stage having, at least one layer having at least one node for determining context information for the at least one node using the content attributes of selected nodes in an other layer or a next stage, and for integrating certain ones of the content attributes and the context information for the at least one node.

3. The data processing device according to claim 2, wherein the at least one node of the second layer of the first stage includes determining the context information from information cascaded from a higher layer or the second stage to the at least one node, and for integrating the information at the at least one node.

4. The data processing device according to claim 1, wherein each stage is associated with a set of a hierarchical priors.

5. The data processing device according to claim 1, wherein each stage is represented by a Bayesian network.

6. The data processing device according to claim 1, wherein the content attributes are selected from the group consisting of audio, visual, keyframes, visual text, and text.

7. The data processing device according to claim 1, wherein the integration of each layer is arranged to combine certain ones of the content attributes and the context information for the at least one node at different levels of granularity.

8. The data processing device according to claim 1, wherein the integration of each layer is arranged to combine certain ones of the content attributes and the context information for the at least one node at different levels of abstraction.

9. The data processing device according to claim 7, wherein the different levels of granularity are selected from the group consisting of the program, sub-program, scene, shot, frame, object, object parts and pixel level.

10. The data processing device according to claim 8, wherein the different level of abstraction is selected from the group consisting of the pixels in an image, objects in 3-D space and transcript text character.

11. The data processing device according to claim 1, wherein the selected nodes are related to each other by directed arcs in a directed acyclic graph (DAG).

12. The data processing device according to claim 11, wherein a selected node is associated with a cpd of an attribute defining the selected node being true given the truthfulness of the attribute associated with a parent node.

13. The data processing device according to claim 1, wherein the first layer is further arranged to group certain ones of the content attributes for the each one of the first plurality of nodes.

14. The data processing device according to claim 1, wherein the nodes of each layer correspond to stochastic variables.

15. A method for processing an information signal comprising the steps of:
segmenting and indexing the information signal using a probabilistic framework, said framework including at least one stage having a plurality of layers with each layer having a plurality of nodes, wherein the segmenting and indexing includes,
extracting content attributes from the information signal for each node of a first layer;
determining context information, in a second layer, using the content attributes of selected nodes in an other layer or a next stage; and
integrating certain content attributes and the context information for at lest one node in the second layer.

16. The method according to claim 15, wherein the determining step includes using the context information from information cascaded from a higher layer or stage to the at least one node, and for integrating the information at the at least one node.

17. The method according to claim 15, wherein the extracting step includes extracting audio, visual, keyframes, visual text, and text attributes.

18. The method according to claim 15, wherein the integrating step includes combining certain ones of the content attributes and the context information for the at least one node at different levels of granularity.

19. The method according to claim 15, wherein the integrating step includes combining certain ones of the content attributes and the context information for the at least one node at different levels of abstraction.

20. The method according to claim 18, wherein the different levels of granularity are selected from the group consisting of the program, sub-program, scene, shot, frame, object, object parts and pixel level.

21. The method according to claim 19, wherein the different level of abstraction are selected from the group consisting of the pixels in an image, objects in 3-D space and character.

22. The method according to claim 15, wherein the determining step includes using directed acyclic graphs (DAGs) that relate the content attributes of selected nodes in an other layer or a next stage.

23. A computer-readable memory medium including code for processing an information signal, the code comprising:
framework code said framework including at least one stage having a plurality of layers with each layer having a plurality of nodes, wherein the segmenting and indexing includes,
feature extracting code to extract content attributes from the information signal for each node of a first stage;
probability generating code to determine context information, in a node of a stage, using the content attributes of selected nodes in other layers or context information of a next stage; and
integrating code to combine certain content attributes and the context information for a node.

24. The memory medium according to claim 23, wherein the probability generating code further includes using context information cascaded from higher layers or stages to a node, and for integrating the cascaded information at the node.

25. The memory medium according to claim 23, wherein each stage is associated with a set of priors in a hierarchical prior system.

26. The memory medium according to claim 23, wherein the stages are represented by a Bayesian network.

27. The memory medium according to claim 23, wherein the content attributes are selected from the group consisting of audio, visual, keyframes, visual text, and text.

28. The memory medium according to claim 23, wherein each layer is arranged to combine certain ones of the content attributes and the context information for a node at different levels of granularity.

29. The memory medium according to claim 23, wherein each layer is arranged to combine certain ones of the content attributes and the context information for a node at different levels of abstraction.

30. The memory medium according to claim 28, wherein the different levels of granularity are selected from the group consisting of the program, sub-program, scene, shot, frame, object, object parts and pixel level.

31. The memory medium according to claim 29 wherein the different level of abstraction are selected from the group consisting of the pixels in an image, objects in 3-D space and character.

32. The memory medium according to claim 23, wherein the selected nodes are related to each other by directed arcs in a directed acyclic graph (DAG).

33. The memory medium according to claim 32, wherein a selected node is associated with a cpd of an attribute defining the selected node being true given the truthfulness of the attribute associated with a parent node in an other layer or a next stage.

34. The memory medium according to claim 23, wherein the nodes of each layer correspond to stochastic variables.

35. An apparatus for processing an information signal, the apparatus comprising:
a memory which stores process steps; and
a processor which executes the process steps stored in the memory so as (i) to use at least one stage with a plurality of layers with at least one node in each layer, (ii) extract content attributes from the information signal for each node of a first layer, (iii) to determine context information, in a second layer, using the content attributes of selected nodes in an other layer or context information of a next stage; and (iv) to combine certain content attributes and the context information for a node.
